(19) United States
(12) Patent Application Publication
(10) Pub. No.: US 2025/0135702 A1
(43) Pub. Date: May 1, 2025

(54) Uniform distribution of cooling gas plenum

(71) Applicant: Addex, Inc., Newark, NY (US)

(72) Inventors: Robert E. Cree, Conroe, TX (US); William Wilck, Newark, NY (US); Josiah Austin, Marion, NY (US)

(21) Appl. No.: 18/385,145

(22) Filed: Oct. 30, 2023

(51) Int. Cl. B29C 48/88; B29C 48/10; B29C 48/885

(52) U.S. Cl. CPC B29C 48/912; B29C 48/10; B29C 48/885

(57) ABSTRACT

Embodiments of the present disclosure provides an air ring plenum. The air ring plenum includes an interior circumferential plenum opening. The air ring plenum further includes an inlet located on an exterior surface of the air ring plenum, the inlet includes a hollow passageway fluidly connected to the interior volume of the air ring plenum. The air ring plenum includes at least one divider plate, an upper interior surface of the air ring plenum and the divider plate defining a first upper channel circumscribed around the plenum opening, and a lower interior surface of the air plenum and the divider plate defining a second lower channel also circumscribed around the plenum opening.

### BACKGROUND OF THE INVENTION

### Field of the Invention

The present disclosure relates to a method and apparatus for cooling. The present disclosure relates more particularly to a method and apparatus for uniform cooling.

### Description of Related Art

Various methods to manufacture thermoplastic blown films are well known in the plastics art, and typically involve forming a continuous, vertically oriented, seamless, annular plastic film commonly referred to as the “tube” or “bubble”. Thermoplastic material is melted and pumped by an extruder through a blown film die (die), exiting as an annular flow of a molten film, continuously drawn upward by a pair of driven squeeze rollers, flowing generally upward from the die through a cooling system, where cooling gas is applied to the exterior surface of the bubble as it stretches, expands, and cools around a trapped column of gas that is injected through the die for the purpose of inflating the bubble to a desired size. In some cases, cooling gas is also used as the injected gas through the die, which then simultaneously inflates and assists in cooling the molten film tube until it solidifies at a frost line into a solidified film tube. The solidified film tube passes through various stabilizers and enters a flattening device, which converts the tube into a flattened double thickness thermoplastic sheet of film known as “lay-flat”. The lay-flat passes through the driven squeeze rollers, and is conveyed to downstream converting equipment such as winders and bag making machines for further processing.

Blown film cooling systems provide a flow of cooling gas externally, and in some cases also internal to the molten film tube. Cooling systems are designed using well known Bernoulli and Coanda principles, and typically apply the cooling gas to flow generally along the surface of the molten film tube providing for both stability and cooling of the molten film tube.

### SUMMARY OF THE INVENTION

In view of the foregoing, it is an object of the present disclosure to provide a method and apparatus for uniform distribution of cooling gas.

A first exemplary embodiment of the present disclosure presents an apparatus for cooling. The apparatus includes an air ring plenum, the air ring plenum having an interior circumferential plenum opening, the air ring plenum further having an inlet located on an exterior surface of the air ring plenum, the inlet comprising a hollow passageway fluidly connected to the interior volume of the air ring plenum, the air ring plenum including at least one divider plate, an upper interior surface of the air ring plenum and the divider plate defining a first upper channel circumscribed around the plenum opening, and a lower interior surface of the air ring plenum and the divider plate defining a second lower channel also circumscribed around the plenum opening. The first channel and the second channel are fluidly connected to the inlet.

A second exemplary embodiment includes an apparatus including a blown film die operable for producing a molten film tube, and an air ring plenum comprising an inlet fluidly connected to an interior circumferential plenum opening. The air ring plenum includes at least one divider plate circumscribing the plenum opening, a top interior surface of the air ring plenum and the divider plate defining a first upper channel that circumscribes the plenum opening, a bottom interior surface of the air ring plenum and the divider plate defining a second lower channel that circumscribes the plenum opening, the first channel and the second channel are fluidly connected to the inlet to receive cooling gas. The apparatus further includes at least one cooling element fluidly connected to the air ring plenum, the cooling element operable for receiving cooling gas from the first upper channel and the second lower channel through the plenum opening.

A third exemplary embodiment includes providing a molten film tube from a blown film die, and cooling the molten film tube by at least one cooling element, the at least one cooling element operable to receive cooling gas from an air ring plenum having an interior circumferential plenum opening and an inlet located on an exterior surface of the air ring plenum, the inlet body comprising a hollow passageway fluidly connected to an interior volume of the air ring plenum, the air ring plenum including at least one divider plate, the at least one divider plate and an upper interior surface defining a first upper channel circumscribed around the plenum opening, the at least one divider plate and a lower interior surface defining a second lower channel circumscribed around the plenum opening, wherein the first upper channel and the second lower channel are fluidly connected to the inlet.

The following will describe embodiments of the present invention, but it should be appreciated that the present invention is not limited to the described embodiments and various modifications of the invention are possible without departing from the basic principles. The scope of the present disclosure is therefore to be determined solely by the appended claims.

### BRIEF DESCRIPTION OF THE DRAWINGS

FIG. 1 is a perspective view of a device suitable for use in practicing exemplary embodiments of this disclosure.

FIG. 2 is a top view of a device suitable for use in practicing exemplary embodiments of this disclosure.

FIG. 3 is a side view of a device suitable for use in practicing exemplary embodiments of this disclosure.

FIG. 4 is a graphical representation of one form of upper and lower air flows suitable for use in practicing exemplary embodiments of this disclosure.

FIG. 5 is a vertical cross-sectional view of a blown film device showing the location of the device suitable for use in practicing exemplary embodiments of this disclosure.

FIG. 6 is a close-up cross-sectional view of a device suitable for use in practicing exemplary embodiments of this disclosure shown in alternate arrangement on a blown film process.

FIG. 7 is a front view of the radial interior surface of three embodiments of a device suitable for use in practicing exemplary embodiments of this disclosure.

### DETAILED DESCRIPTION OF THE INVENTION

Exemplary embodiments of the present disclosure relate to a cooling system for a blown film tubular extrusion process. Embodiments include a single inlet plenum operable to deliver improved circumferential uniformity of cooling gas to one or more lip sets. Embodiments provide an improved cooling system operable to produce high quality films at greater efficiency. Embodiments of the cooling system include an air ring plenum having an interior circumferential plenum opening, with two or more channels that circumscribe around the plenum opening, acting to distribute cooling gas such that the combined flow passing from the two or more channels through the plenum opening to the one or more lip sets is circumferentially uniform.

In one embodiment the air ring plenum includes two or more channels associated with an inlet. The two or more channels each wrap interior within the air ring plenum and circumscribe around the interior plenum opening. Embodiments provide a relatively equal or uniform circumferential distribution of cooling gas to flow through the interior plenum opening from the air ring plenum. In another embodiment, two channels are used, each operable in combination to provide uniform or equal distribution of cooling gas circumferentially to flow through the interior plenum opening from the plenum. In this embodiment, the two channels are arranged such that cooling gas received from the inlet flows to each of the two channels which act to direct cooling gas to flow in opposite directions around the interior of the plenum. The resulting two cooling gas flows passing circumferentially inward from each of the channels provide equal and opposite flow behavior as a function of position around the channels such that the combined flow of cooling gas from each channel passing through the interior plenum opening from the air ring plenum and delivered to the lip sets is uniform with a resulting uniform influence on the associated film being produced.

It should be noted that the two or more channels can have linear or non-linear circumferential flow rate distribution curves so long as the combination of the cooling gas flowing from the air ring plenum to the lip sets from the multiple of channels through the interior plenum opening is circumferentially uniform.

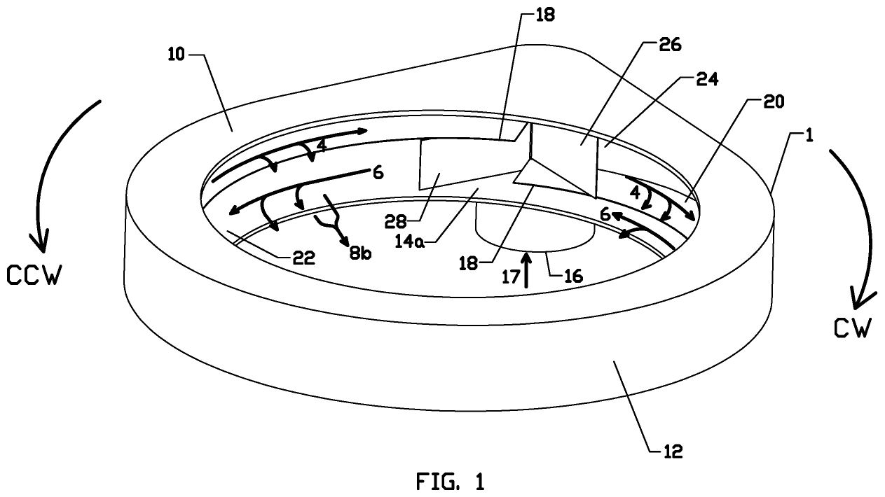

In FIGS. 1-7, all thick arrows indicating a direction are for illustrative purposes only, and indicate a direction of flow of a fluid (e.g. cooling gas).

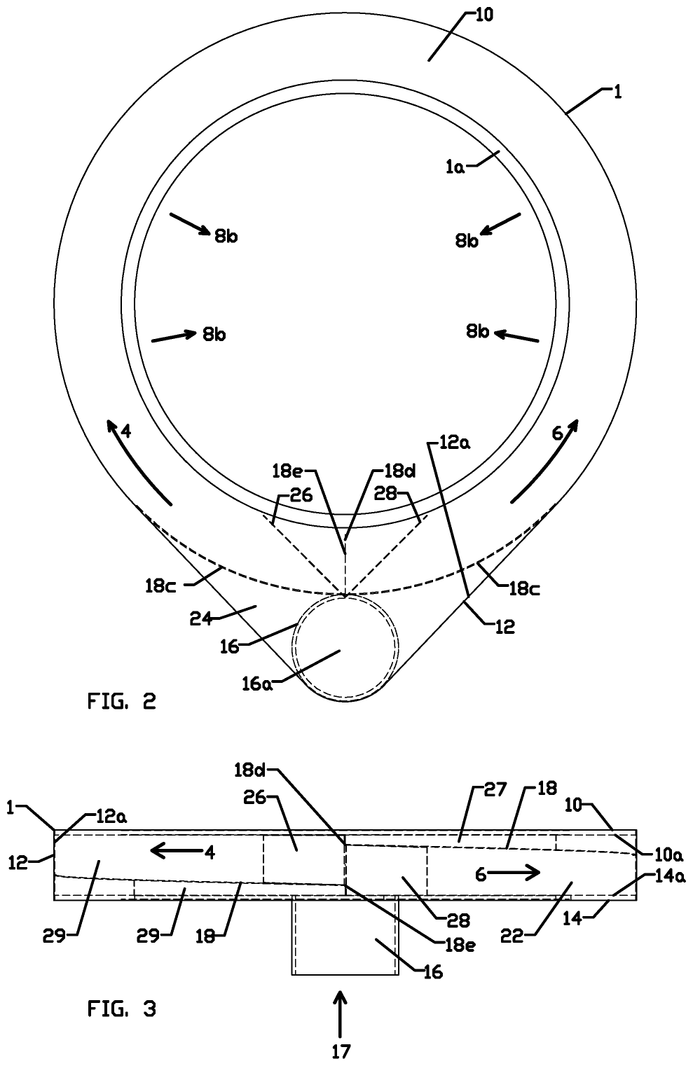

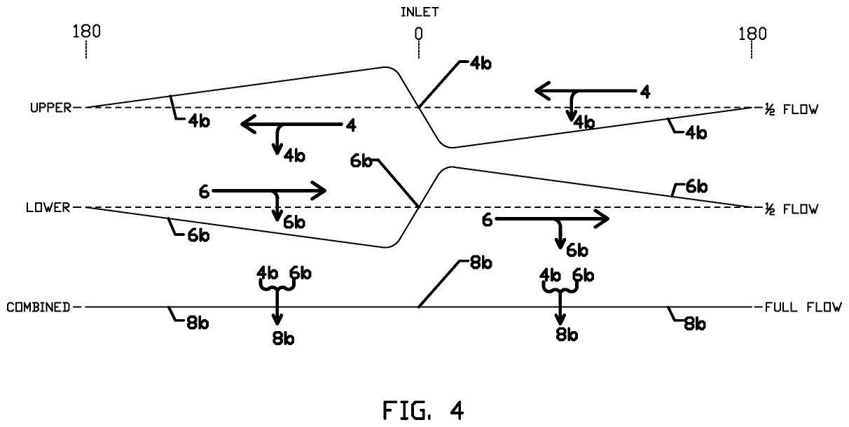

FIGS. 1-3 depict one embodiment of air ring plenum 1 having an inlet body 16 defining an inlet 16a (shown in FIG. 2), an upper wall 10 with upper interior surface 10a, an outer wall 12 with radially interior surface 12a, and lower wall 14 with lower interior surface 14a (shown in FIG. 3) that together form the mechanical extents of air ring plenum 1. The interior radial edge of upper interior surface 10a and the interior radial edge of lower interior surface 14a define a plenum opening 1a, which circumscribes the open radial interior of air ring plenum 1.

Air ring plenum 1 includes a divider plate 18 that is fixedly attached to radially interior surface 12a along an outer radial perimeter 18c of divider plate 18 except near the area of inlet body 16. Divider plate 18 circumscribes plenum opening 1a and is located between upper interior surface 10a and lower interior surface 14a. As shown in FIG. 2, inlet body 16 is radially offset between an outer radial perimeter 18c of divider plate 18 and the radially interior surface 12a. Radially interior surface 12a is spaced apart from divider plate 18 near inlet body 16 such that the divider plate 18 is positioned radially inward from the inlet body 16 forming a teardrop shaped air ring plenum 1 with a generally circular divider plate 18 contained within.

The interior of inlet body 16 is hollow. Inlet body 16 has a first open end operable to receive cooling gas and a second open end fluidly connected to the first end. The first open end and the second open end are fluidly connected to an inlet expansion volume 24. Inlet expansion volume 24 is a cavity formed within air ring plenum 1 operable to receive cooling gas 17 from the inlet body 16 through inlet 16a. The extents of inlet expansion volume 24 are upper interior surface 10a, radially interior surface 12a, lower interior surface 14a, and the outer radial perimeter 18c of divider plate 18 projected between the upper interior surface 10a and lower interior surface 14a forming a triangular prism shaped cavity (shown in FIG. 2). The radially offset arrangement of inlet body 16 from divider plate 18 allows cooling gas 17 to flow into the inlet expansion volume 24 unimpeded by divider plate 18.

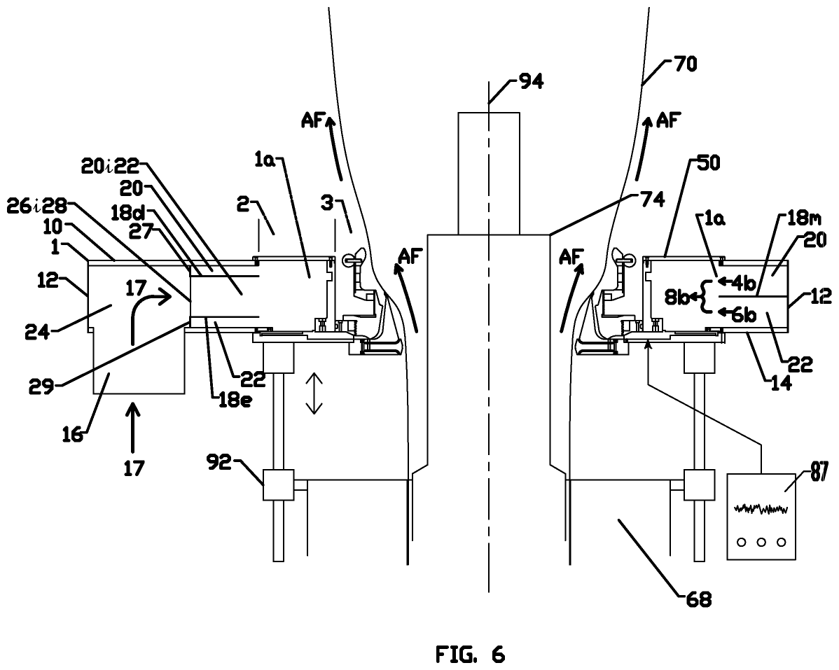

As shown in FIGS. 3 and 6, other than within the inlet expansion volume 24, the divider plate 18 divides the interior volume of air ring plenum 1 into an upper channel 20 and lower channel 22 with radially inner extents formed by plenum opening 1a. Embodiments provide that the radially outer extents of upper channel 20 and lower channel 22 circumscribe the radially interior surface 12a of air ring plenum 1 except near the area of inlet expansion volume 24 where the channels 20, 22 circumscribe the radially inward portion of inlet expansion volume 24. Inlet expansion volume 24 is fluidly connected to upper channel 20 and lower channel 22 such that inlet expansion volume 24 is operable to direct cooling gas 17 to flow through upper channel 20 and lower channel 22 for circumferential distribution through plenum opening 1a.

In practice, cooling gas 17 is directed to simultaneously flow (i) clockwise around upper channel 20 forming a flow of upper cooling gas 4 and (ii) counter-clockwise around lower channel 22 forming a flow of lower cooling gas 6. In this arrangement, upper cooling gas 4 and lower cooling gas 6 are located on opposite sides of divider plate 18. As upper cooling gas 4 and lower cooling gas 6 flow through channels 20, 22, respectively, portions of upper cooling gas 4 and lower cooling gas 6 flow generally radially inward through interior plenum opening 1a as upper bleed gas 4b (shown in FIGS. 1 and 4) and lower bleed gas 6b (shown in FIGS. 1 and 4). As upper bleed gas 4b and lower bleed gas 6b flow radially inward circumferentially through plenum opening 1a they will form an inward radial flow of uniform combined cooling gas 8b (shown in FIGS. 2 and 4). The cooling gas flow rates of upper bleed gas 4b and lower bleed gas 6b flow inwardly together to create a uniform combined cooling gas 8b circumferential flow, which is conceptually similar to the well-known graphic arts form known as regular division of the plane, where in this case a variety of cooling gas flow rates perfectly interact and sum to create in this case a combined uniform flow of cooling gas. It should be appreciated that embodiments include reversing the direction of channel flows (i.e., upper cooling gas 4 and lower cooling gas 6) to achieve similar uniform combined cooling gas 8b regular division results.

Reference is now made to FIG. 3 which illustrates an upper termination wall 27 attached to the outer radial perimeter 18c of divider plate 18 and extending to upper interior surface 10a. Upper termination wall 27 is located on the outer radial perimeter 18c such that it extends counter-clockwise from the terminal edge 18d (shown in FIGS. 1, 3, and 6) of divider plate 18 in the region of inlet expansion volume 24 (shown in dotted line in FIG. 2). Upper termination wall 27 is operable to block counter-clockwise directional flow and encourage clockwise directional flow in upper channel 20 of upper cooling gas 4. A lower termination wall 29 is attached to the outer radial perimeter 18c of divider plate 18 and extending to lower interior surface 14a. Lower termination wall 29 is located on the outer radial perimeter 18c such that it extends clockwise from the terminal edge 18e (shown in FIGS. 1, 3, and 6) of divider plate 18 in the region of inlet expansion volume 24 (shown in dotted line in FIG. 2). Lower termination wall 29 is operable to block clockwise directional flow and encourage counter-clockwise directional flow in lower channel 22 of lower cooling gas 6. Also shown for reference in FIG. 6 is a divider plate midpoint 18m which depicts the general location of the 180 degree midpoint of divider plate 18 from terminal edge 18e and terminal edge 18d.

To assist in developing fully redirected clockwise circumferential upper cooling gas 4 flow in upper channel 20, upper flow director 26 is provided and arranged to extend clockwise and inwardly spaced apart from radially interior surface 12a beginning generally from the outer perimeter of divider plate 18 at a point radially in line with the center of inlet body 16. Flow director 26 is fixedly attached to upper interior surface 10a and the surface of divider plate 18 facing upper channel 20. Similarly, to assist in developing fully redirected counter-clockwise circumferential lower cooling gas 6 flow in lower channel 22, lower flow director 28 is provided, arranged to extend counter-clockwise and inwardly spaced apart from radially interior surface 12a beginning generally from the outer perimeter of divider plate 18 at a point radially in line with the center of inlet body 16. Flow director 28 is fixedly attached to lower interior surface 14a and the surface of divider plate 18 facing lower channel 22.

As shown in FIG. 3, divider plate 18 can be split in one location along an axis radially in line with the center of inlet body 16 such that divider plate 18 includes terminal edge 18d, 18e. The spacing of divider plate 18 intermediate the upper interior surface 10a and lower interior surface 14a is depicted as variable to allow for the mechanical selection of the cross-sectional area of upper channel 20 and lower channel 22. In the arrangement presented with beginning and end referenced in the direction of flow of upper cooling gas 4, the beginning of upper channel 20 has a larger spacing than the end of upper channel 20 and the associated cross sectional area linearly tapers circumferentially clockwise from a larger to a smaller cross sectional area to an open end which feeds back into the beginning of upper channel 20, creating an overlap flow of upper cooling gas 4 located at the split in the divider plate 18 that forms upper channel 20. Similarly, with beginning and end now referenced in the direction of flow of lower cooling gas 6, the beginning of lower channel 22 has a larger spacing than the end of lower channel 22 and the associated cross sectional area linearly tapers circumferentially counter-clockwise from a larger to a smaller cross sectional area to an open end which feeds back into the beginning of lower channel 22, creating an overlap flow of lower cooling gas 6 located at the split in the divider plate 18 that forms lower channel 22.

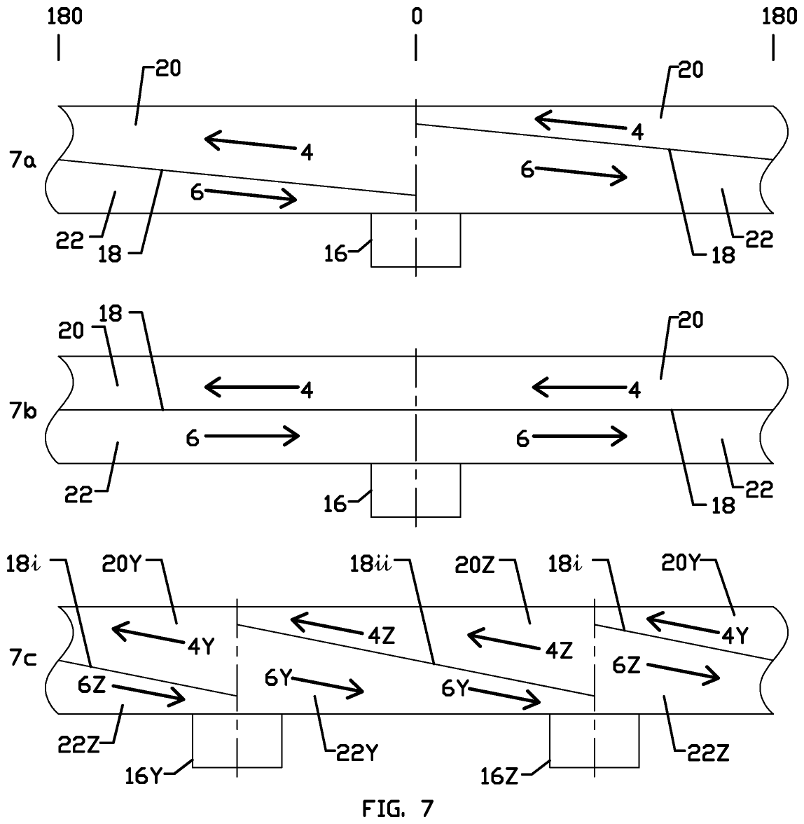

The ends in the direction of flow of cooling gas 4, 6 are depicted for upper channel 20 and lower channel 22 as being open, but it should be appreciated that embodiments include the ends of channels 20, 22 also being covered by a solid or perforated material such that the flow of cooling gas is partially or fully obstructed from continuing to flow through channels 20, 22. In addition, upper flow director 26 and lower flow director 28 are depicted and in one embodiment can employ perforated material acting to simultaneously assist in forming circumferential flow and to allow upper cooling gas 4 and lower cooling gas 6 to flow through the perforated material respectively. Embodiments of perforated material include a screen material, a porous material, or a solid plate having numerous holes therethrough. Optionally, upper flow director 26 and lower flow director 28 can be omitted, be solid, or perforated as desired. Further, upper interior surface 10a and lower interior surface 14a can be variable in spacing, but are depicted to be spaced parallel to one another such that the respective circumferential cross-sectional area profile of upper channel 20 and lower channel 22 are inverted mirror images of one another (shown in FIG. 7). This adjacently spaced inverted mirror image arrangement formed between channels 20 and 22, provides a mechanical layout that allows air ring plenum 1 to be constant in height around its circumference and circular in geometry with a single inlet body 16 spaced outwardly apart from the cooling of blown film for convenient connection of cooling gas 17. This significantly simplifies the design and reduces the mechanical footprint of the number of hoses, devices, cables, cords, etc. required for the cooling of blown film and the manufacturing costs over prior art designs. The respective circumferential cross-sectional area profile of upper channel 20 and lower channel 22 can be any profile such as linear decreasing taper (shown in FIG. 7), constant, linear increasing, or complex curved increasing or decreasing, as long as the resulting circumferential flow profile for upper bleed gas 4b and lower bleed gas 6b circumferentially add to create a uniform combined cooling gas 8b flow.

FIG. 4 graphically depicts a regular division example of the relative magnitude of upper bleed gas 4b and lower bleed gas 6b that add to create a uniform combined cooling gas 8b flow, depicted clockwise and counter-clockwise beginning radially in line with the center of inlet body 16 circumferentially along upper channel 20 and lower channel 22. Shown in FIG. 4 are graphical representations of the direction of flow of cooling gas 4 and 6, and bleed gas 4b and 6b through and the relative circumferential magnitude of bleed gas 4b and 6b flow out of (i) the upper channel 20, (ii) the lower channel 22, and (iii) the cumulative flow bled circumferentially from the upper channel 20 and the lower channel 22. The top X-axis represents the radial location along the open interior of upper channel 20 and lower channel 22 from 0 degrees (i.e., the location of the inlet body 16) clockwise and counter-clockwise to 180 degrees from the center of inlet body 16. The Y-axis represents the amount of bleed gas 4b and 6b that passes radially inward from the channels. When Y=0, the flow of bleed gas equals ½ of what is required circumferentially to create the uniform combined cooling gas 8b flow.

As shown in FIG. 4, the change in the rate of flow of the bleed gas as you move along the X-axis is substantially linear except near the area close to X=0 where mechanical discontinuity at the channel overlap point located in line with inlet body 16 forms a relatively non-linear transition in upper bleed gas 4b and lower bleed gas 6a. These non-linearities are generally S-shaped and substantially fit together to satisfy regular division requirements, thus they also properly combine together, although with an entirely different regular division shape, to form uniform combined cooling gas 8b flow. Each of the upper channel 20 and lower channel 22 are operable to encourage a substantially regularly divided upper bleed gas 4b and mirror image lower bleed gas 6b respectively around the entire interior circumference which combine together to form uniform combined cooling gas 8b flow.

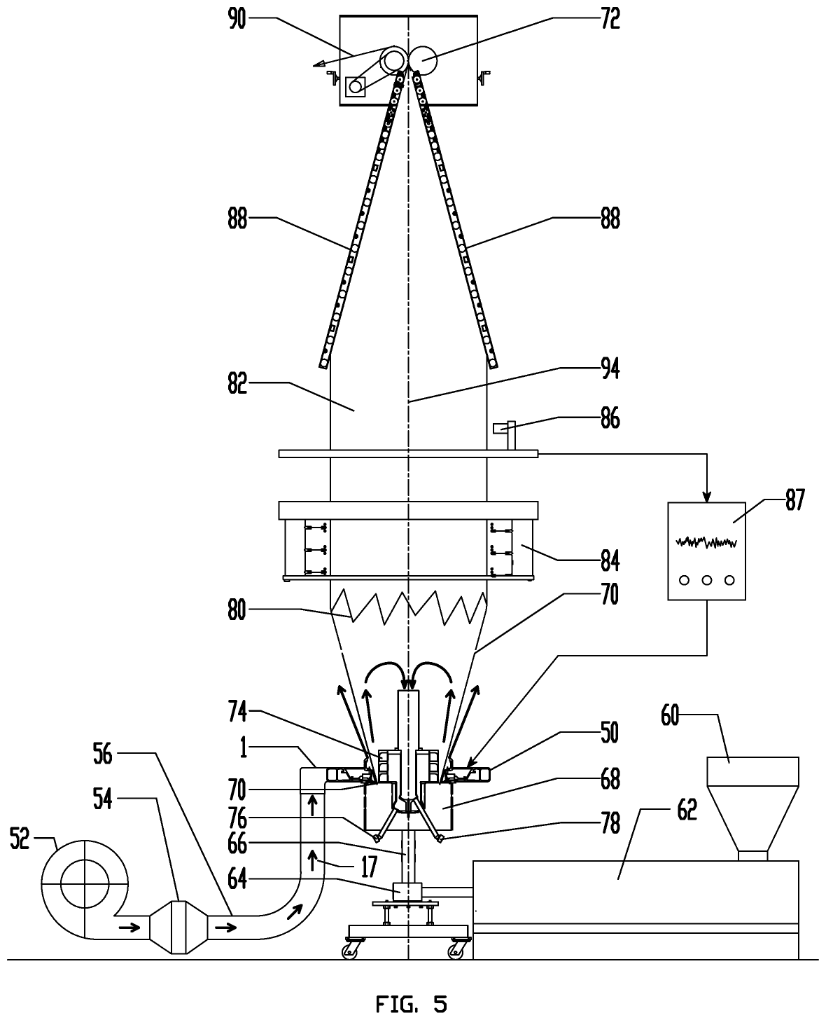

FIG. 5 is a vertical cross-sectional view of a blown film extrusion line. Pressurizing blower 52 provides pressurized cooling gas 17 through optional cooling box 54 and main cooling pipe 56 to air ring plenum 1 which forms the outer portion of cooling ring 50. Plastic pellets pass from feed hopper 60 into extruder 62 where they are melted, mixed and pressurized as plastic melt 70 to flow upward through die block 64 and die mount 66 into die 68 which acts to form plastic melt 70 into an annular ring that exits vertically at the top of die 68. Plastic melt 70 is continuously pulled upward by squeeze rollers 72 around internal cooler 74 and through cooling ring 50 generally concentric with process centerline 94, and which acts to cool plastic melt 70.

Internal pressure is applied to the plastic melt 70 by internal cooler 74 by way of internal cooler supply pipe 76 which causes bubble plastic melt 70 to expand in diameter until solidified at frost line 80 to form bubble 82. Internal cooler exhaust pipe 78 removes excess gas from inside the bubble 82 once it has reached the desired size.

Bubble 82 then passes through optional cage 84 which acts to prevent excessive movement of bubble 82 as it conveys upward though optional thickness profiler 86 and optional automatic profile controller 87 that act to selectively control the thickness profile of bubble 82, and then into collapsing frame 88. Collapsing frame 88 compresses bubble 82 into a double thickness film connected at both ends that passes through squeeze rollers 72 to form layflat web 90. Layflat web 90 is then processed further by known techniques into a variety of products.

FIG. 6 is a close-up cross-sectional view of a typical cooling ring 50 integrated with an exemplary embodiment single inlet outer air ring plenum 1 depicted with a cross section that passes through the center of inlet body 16. Air ring plenum 1 is arranged to surround straightening and adjusting section 2 such that uniform combined cooling gas flow 8b flows directly from plenum opening 1a into straightening and adjusting section 2 acting to eliminate any spiraling direction gas flows that may be present. The radially outer portion of the straightening and adjusting section 2 provides an open volume that receives cooling gas directly from plenum opening 1a. It is understood that the radial mating position of the upper and lower walls where plenum 1 and straightening and adjusting section 2 meet, may advantageously be adjusted relative to plenum opening 1a to simplify mechanical assembly while still providing an open volume inside of plenum opening 1a to allow mixing of upper bleed gas 4b and lower bleed gas 6b circumferentially to create a uniform combined cooling gas 8b flow. FIG. 6 illustrates one embodiment in which the upper and lower walls of straightening and adjusting section 2 overlay a portion of the exterior surface of upper wall 10 and lower wall 14 of plenum 1. In another embodiment, upper wall 10 and lower wall 14 of plenum 1 overlay the exterior surface of the upper and lower walls of straightening and adjusting section 2.

Optionally, straightening and adjusting section 2 also typically contains any profile control regulation devices which might be integrated within cooling ring 50. Embodiments of a profile control regulation device include an automatic profile control regulation device and a manual profile control regulation device. An exemplary automatic profile control regulation device includes at least one optional thickness profiler 86 operable to sense a circumferential thickness profile of the bubble 82, a straightening and adjusting section 2 that is operable to circumferentially vary the cooling gas flow by acting to increase or decrease the amount of, or increase or decrease the temperature of cooling gas that is received by the surface of the bubble 82 from the cooling element, in circumferential response to an optional automatic profile controller 87 operable to receive the sensed thickness profile of the bubble 82 and to automatically circumferentially adjust the straightening and adjusting section 2 to minimize the circumferential variability of the thickness profile of the bubble 82. It should be appreciated that embodiments include use of an automatic profile control regulation device or a manual profile control regulation device. Embodiments of the manual profile control regulation device can include at least one optional thickness profiler 86 operable to sense bubble thickness and a straightening and adjusting section 2 that can be manually manipulated by a user to increase or decrease the amount of cooling gas that is received by the surface of the bubble 82. Straightening and adjusting section 2 also may not include any form of circumferential adjustment, and in this case typically surrounds and guides unadjusted uniform combined cooling gas flow 8b into lip sets section 3, where one or more lip sets apply the unadjusted uniform combined cooling gas flow 8b to cool plastic melt 70. In one embodiment, the straightening and adjusting section 2 includes a plurality of channels or holes that can be selectively opened and closed that are fluidly connected between the air ring plenum 1 and the cooling element. Optional thickness profiler 86, optional automatic profile controller 87, straightening and adjusting section 2 (with and without automatic profile regulation devices) and lip sets section 3 are common and well understood within the industry.

For reference, internal cooler 74 technology is generally depicted and applies cooling gas internal to plastic melt 70 to achieve higher cooling performance. Inlet body 16, top wall 10, outer wall 12, bottom wall 14, upper channel 20, lower channel 22, upper channel termination wall 27, and lower channel termination wall 29 are also shown for reference.

Flow director 26 and 28 generally meet radially in line with the center of inlet body 16 at flow director interface 26128, which is the location where the edge of clockwise extending flow director 26 meets the edge of counter-clockwise extending flow director 28. Flow director 26 extends clockwise from flow director interface 26128 and flow director 28 extends counter-clockwise from flow director interface 26128. Similarly, channel interface area 20122 is the area generally radially in line with the center of inlet body 16 fluidly connected to inlet expansion volume 24 where the entry into upper channel 20 adjacently meets with the entry into lower channel 22.

Cooling ring 50 is generally arranged coaxial with and spaced apart from die 68 and can either be fixed in position relative to die 68 as shown in FIG. 5 or alternately height adjustment mechanism 92 can be incorporated as shown in FIG. 6 to move cooling ring 50 generally in the direction of and coaxial with process centerline 94. Embodiments include cooling ring 50 with air ring plenum 1 being either fixed or height adjustable with respect to die 68 while cooling plastic melt 70. For instance, in one embodiment cooling ring 50 with air ring plenum 1 is operable to be moved to a plurality of locations with respect to die 68 along the long axis of bubble 82 such that cooling ring 50 with air ring plenum 1 is in contact with die 68 or spaced from die 68.

FIG. 7 illustrates alternative simplified exemplary embodiments of outer air ring plenum 1. Shown in FIG. 7b is an apparatus diagram of an alternate regular division capable single inlet outer plenum with a different divider plate 18 arrangement, and in FIG. 7c an apparatus diagram illustrating a two-inlet regular division capable outer plenum, each in comparison to FIG. 7a, the exemplary embodiment single inlet regular division capable air ring plenum 1. As shown in 7a, air ring plenum 1 includes a single divider plate 18 that circumscribes fully around plenum opening 1a such that there is a single upper channel 20 and a lower channel 22 of variable mirror image dimension. Referring now to FIG. 7b, an alternate arrangement of divider plate 18 is presented which acts to create uniform and equally shaped upper channel 20 and lower channel 22. In this embodiment divider plate 18 does not have a terminal edge 18d or terminal edge 18e because they are connected or integral with one another.

Shown in 7c is an alternative embodiment in which there are two inlet body's 16Y and 16Z, and two divider plates 18i and 18ii. Divider plate 18i circumscribes ½ way around the interior of the outer plenum and only extends from in line with inlet body 16Y to in line with inlet body 16Z. Divider plate 18ii circumscribes the remaining interior ½ of the outer plenum and only extends from in line with inlet body 16Z to in line with inlet body 16Y. In this embodiment, upper channel 20Z receives cooling gas from inlet body 16Z and terminates at the terminal end of divider plate 18ii. However, cooling gas that flows through the terminal end of divider plate 18ii does not flow back into upper channel 20Z. Rather, the cooling gas flows into upper channel 20Y.

Any number of inlets can be implemented, however only two inlets are presented for illustration purposes, depicted as similar inlet body 16Y and second similar inlet body 16Z, similar upper channel 20Y and second similar upper channel 20Z, similar lower channel 22Y and second similar lower channel 22Z, similar upper cooling gas 4Y flow and second similar upper cooling gas 4Z flow, and similar lower cooling gas 6Y flow and second similar lower cooling gas 6Z flow respectively. Unlike the single inlet case where cooling gas originating from a common inlet body 16 acts through regular division to distribute cooling gas flow, instead, cooling gas from adjacent similar inlet body 16Y and second similar inlet body 16Z act through regular division to distribute cooling gas flow.

For two inlets, similar upper cooling gas 4Y flow regularly divides with second similar lower cooling gas 6Z flow, and similar upper cooling gas 6Y flow regularly divides with second similar lower cooling gas 4Z flow to create uniform combined cooling gas 8b flow (not shown).

Embodiments of the present invention have been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. An apparatus for cooling, the apparatus comprising:
an air ring plenum comprising an interior circumferential plenum opening and an inlet located on an exterior surface of the air ring plenum, the inlet comprising a hollow passageway fluidly connected to an interior volume of the air ring plenum, the air ring plenum including at least one divider plate, the at least one divider plate and an upper interior surface defining a first upper channel circumscribed around the plenum opening, the at least one divider plate and a lower interior surface defining a second lower channel circumscribed around the plenum opening, wherein the first upper channel and the second lower channel are fluidly connected to the inlet.

2. The apparatus of claim 1, wherein the least one divider plate comprises a first divider plate and a second divider plate each located in the plenum opening, and the air ring plenum further comprises a second inlet, and wherein the second divider plate defines a third upper channel and a fourth lower channel.

3. The apparatus of claim 1, the air ring plenum comprising a first flow director located on the first upper channel adjacent the inlet, and a second flow director located on the second lower channel adjacent the inlet.

4. The apparatus of claim 1, wherein the inlet is operable to receive cooling gas and allow the cooling gas to flow through the inlet to the first upper channel and the second lower channel in opposite directions.

5. The apparatus of claim 1, the air ring plenum comprising a first upper termination wall located on an outer radial edge of a portion of the divider plate, the first termination wall operable to prevent cooling gas from directly entering a terminal end of the first upper channel from the inlet, and a second lower termination wall located on the outer radial edge of a portion of the divider plate, the second lower termination wall operable to prevent cooling gas from directly entering a terminal end of the second lower channel from the inlet.

6. The apparatus of claim 5, wherein the at least one divider plate is positioned such that a portion of the first upper channel operable to receive cooling gas from the inlet has a greater cross-sectional area than a portion of the first upper channel that does not receive cooling gas directly from the inlet, and wherein the at least one divider plate is positioned such that a portion of the second lower channel operable to receive cooling gas from the inlet has a greater cross-sectional area than a portion of the second lower channel that does not receive cooling gas directly from the inlet.

7. An apparatus comprising:
a blown film die operable for producing a molten film tube;
an air ring plenum comprising an inlet fluidly connected to an interior circumferential plenum opening, the air ring plenum comprising at least one divider plate circumscribing the plenum opening, a top interior surface of the air ring plenum and the divider plate defining a first upper channel that circumscribes the plenum opening, a bottom interior surface of the air ring plenum and the divider plate defining a second lower channel that circumscribes the plenum opening, the first channel and the second channel are fluidly connected to the inlet to receive cooling gas; and
a cooling element fluidly connected to air ring plenum, the cooling element operable for receiving cooling gas from the first upper channel and the second lower channel through the plenum opening.

8. The apparatus of claim 7, the apparatus further comprising a straightening and adjusting section fluidly connected to the plenum opening, the straightening and adjusting section located such that it is operable to receive cooling gas from the plenum opening and guide the received cooling gas to the cooling element.

9. The apparatus of claim 8, wherein the straightening and adjusting section is circumferentially adjustable by a controller to increase or decrease a flow of cooling gas in response to circumferential thickness profiler measurements of the molten film tube.

10. The apparatus of claim 7, wherein the least one divider plate comprises a first divider plate and a second divider plate each located in the plenum opening, and the air ring plenum further comprises a second inlet, and wherein the second divider plate defines a third upper channel and a fourth lower channel.

11. The apparatus of claim 7, the air ring plenum comprising a first flow director located on the first upper channel adjacent the inlet, and a second flow director located on the second lower channel adjacent the inlet.

12. The apparatus of claim 7, wherein the inlet is operable to receive cooling gas and allow the cooling gas to flow through inlet to the first upper channel and the second lower channel around the plenum opening in opposite directions.

13. The apparatus of claim 7, the air ring plenum comprising a first upper termination wall operable to prevent cooling gas from directly entering a terminal end of the first upper channel from the inlet, and a second lower termination wall operable to prevent cooling gas from directly entering a terminal end of the second lower channel from the inlet.

14. The apparatus of claim 13, wherein the at least one divider plate is positioned such that a portion of the first upper channel operable to receive cooling gas from the inlet has a greater cross-sectional area than a portion of the first upper channel that does not receive cooling gas directly from the inlet.

15. A method for cooling, the method comprising:
(a) providing a molten film tube from a blown film die; and
(b) cooling the molten film tube by at least one cooling element, the at least one cooling element operable to receive cooling gas from an air ring plenum comprising an interior circumferential plenum opening and an inlet located on an exterior surface of the air ring plenum, the inlet body comprising a hollow passageway fluidly connected to an interior volume of the air ring plenum, the air ring plenum including at least one divider plate, the at least one divider plate and an upper interior surface defining a first upper channel circumscribed around the plenum opening, the at least one divider plate and a lower interior surface defining a second lower channel circumscribed around the plenum opening, wherein the first upper channel and the second lower channel are fluidly connected to the inlet.

16. The method of claim 15, wherein the plenum opening of an air ring plenum is fluidly connected to a straightening and adjusting section, the straightening and adjusting section located such that it is operable to receive cooling gas from the plenum opening and guide the received cooling gas to the cooling element.

17. The method of claim 16, wherein the straightening and adjusting section is connected to a controller operable to adjust a flow of cooling gas through the straightening and adjusting section in response to a circumferential thickness profile measurement of the molten film tube.

18. The method of claim 15, wherein the air ring plenum comprises a first flow director located on the first upper channel adjacent the inlet, and a second flow director located on the second lower channel adjacent the inlet.

19. The method of claim 15, wherein the inlet is operable to receive cooling gas and allow the cooling gas to flow through inlet to the first upper channel and the second lower channel in opposite directions around the plenum opening.

20. The method of claim 15, wherein the air ring plenum comprising a first upper termination wall operable to prevent cooling gas from directly entering a terminal end of the first upper channel from the inlet, and a second lower termination wall operable to prevent cooling gas from directly entering a terminal end of the second lower channel from the inlet.

21. The method of claim 20, wherein the at least one divider plate is positioned such that a portion of the first upper channel operable to receive cooling gas from the inlet has a greater cross-sectional area than a portion of the first upper channel that does not receive cooling gas directly from the inlet, and wherein the at least one divider plate is positioned such that a portion of the second lower channel operable to receive cooling gas from the inlet has a greater cross-sectional area than a portion of the second lower channel that does not receive cooling gas directly from the inlet.
